(19) United States
(12) Patent Application Publication
(10) Pub. No.: US 2014/0133760 A1
(43) Pub. Date: May 15, 2014

(54) RASTER TO VECTOR MAP CONVERSION

(71) Applicant: QUALCOMM INCORPORATED, San Diego, CA (US)

(72) Inventors: Hui Chao, San Jose, CA (US); Abhinav Sharma, Santa Clara, CA (US); Saumitra Mohan Das, Santa Clara, CA (US)

(73) Assignee: QUALCOMM Incorporated, San Diego, CA (US)

(21) Appl. No.: 13/789,202

(22) Filed: Mar. 7, 2013

Related U.S. Application Data
(60) Provisional application No. 61/727,046, filed on Nov. 15, 2012.

(51) Int. Cl. G06T 3/00

(52) U.S. Cl. CPC G06T 3/0012
USPC 382/197

(57) ABSTRACT

A computer-implemented method for converting a raster image map to a vector image map includes receiving an electronic raster image that shows an indoor map of a building structure. The method also includes determining whether the indoor map is a line map. If not, the indoor map is converted into a line map. Next, the electronic raster image is processed to generate a processed raster image of the indoor map. The method then extracts vector lines from the processed raster image to generate an electronic vector image that includes the indoor map of the building structure.

### CROSS-REFERENCE TO RELATED APPLICATION

This application claims the benefit of U.S. Provisional Application No. 61/727,046, filed Nov. 15, 2012. U.S. Provisional Application No. 61/727,046 is hereby incorporated by reference.

### BACKGROUND

In indoor navigation, wall based venue maps are often used to assist in the estimation of position calculations. From vector-based maps, such as computer-aided design (CAD) maps, the wall structure of a building is used to identify routes in the venue and to generate heat maps for a positioning engine.

Raster maps are flattened bitmap images without semantic information. Commonly, for a large number of venues, raster maps are readily available to the public, but vector maps are not. However, inferring the wall structure from a raster map may be difficult as the styles of raster maps can be very different. Also, annotations, such as signs for dining areas, restrooms, banks, etc., often obscure features of the building structure.

### BRIEF SUMMARY

In indoor navigation, wall based venue maps are often used to assist in the estimation of position calculations. From vector-based maps, such as computer-aided design (CAD) maps, the wall structure of a building is used to identify routes in the venue and to generate heat maps for a positioning engine.

Raster maps are flattened bitmap images without semantic information. Commonly, for a large number of venues, raster maps are readily available to the public, but vector maps are not. However, inferring the wall structure from a raster map may be difficult as the styles of raster maps can be very different. Also, annotations, such as signs for dining areas, restrooms, banks, etc., often obscure features of the building structure.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a process of converting a raster image of an indoor map into a vector image, in accordance with some embodiments of the present invention.

FIG. 2A is a user interface for receiving a raster image and selecting a map type in accordance with some embodiments of the present invention.

FIG. 2B illustrates a process of automatically determining whether the indoor map is a line map in accordance with some embodiments of the present invention.

FIG. 3 illustrates an example of a raster image including a line map.

FIG. 4 illustrates an example of a raster image including a color-block map.

FIG. 5 illustrates an example of a raster image including a hybrid map.

FIG. 6 illustrates the processing of a raster image map in accordance with some embodiments of the present invention.

FIG. 7 illustrates a user interface for selecting various options for the processing of a raster image map, in accordance with some embodiments of the present invention.

FIGS. 8A and 8B illustrate the conversion of a line map from a raster image to a vector image, in accordance with some embodiments of the present invention.

FIG. 9A illustrates an example raster image of a line map having several parallel lines in close proximity to one another.

FIG. 9B illustrates the conversion of the raster image of FIG. 9A into a vector image without line merging, in accordance with some embodiments of the present invention.

FIG. 9C illustrates the conversion of the raster image of FIG. 9A into a vector image with line merging, in accordance with some embodiments of the present invention.

FIG. 10 illustrates a process of converting a color-block map and a hybrid map into a line map, in accordance with some embodiments of the present invention.

FIGS. 11A-11E illustrate a process of converting a raster image of a color-block map into a vector image, in accordance with some embodiments of the present invention.

FIGS. 12A-12C illustrate a process of converting a raster image of a hybrid map into a vector image, in accordance with some embodiments of the present invention.

FIG. 13 illustrates a process of layering the hybrid map of FIG. 12A, in accordance with some embodiments of the present invention.

FIGS. 14A-14B illustrate a process of annotation removal by way of user-selection of color, in accordance with some embodiments of the present invention.

FIGS. 15A-15B illustrate a process of annotation removal by way of user-selection of a region, in accordance with some embodiments of the present invention.

FIG. 16 is a function block diagram of navigation system, in accordance with some embodiments of the present invention.

FIG. 17 is a functional block diagram illustrating a computing device capable of converting a raster image of an indoor map into a vector image, in accordance with some embodiments of the present invention.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

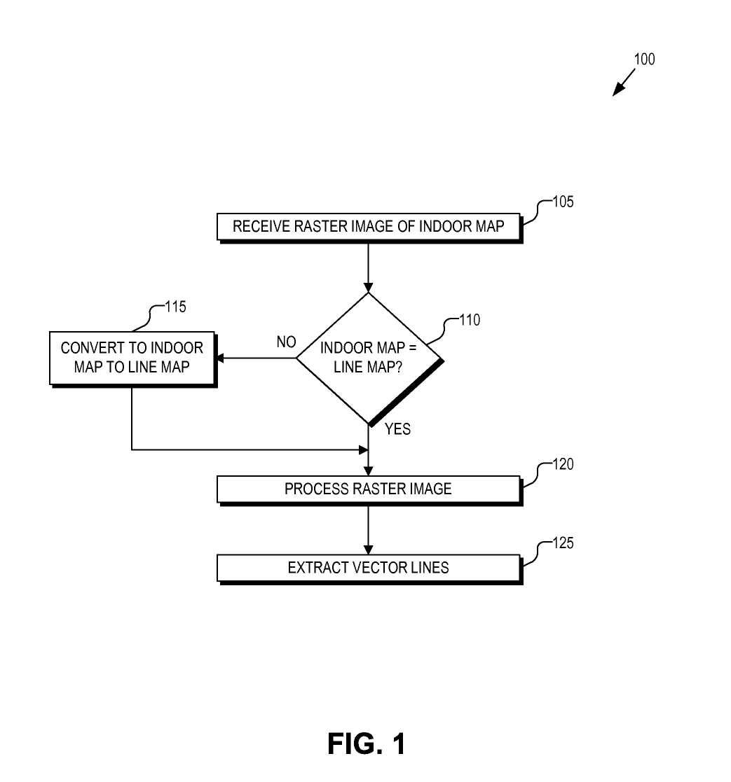

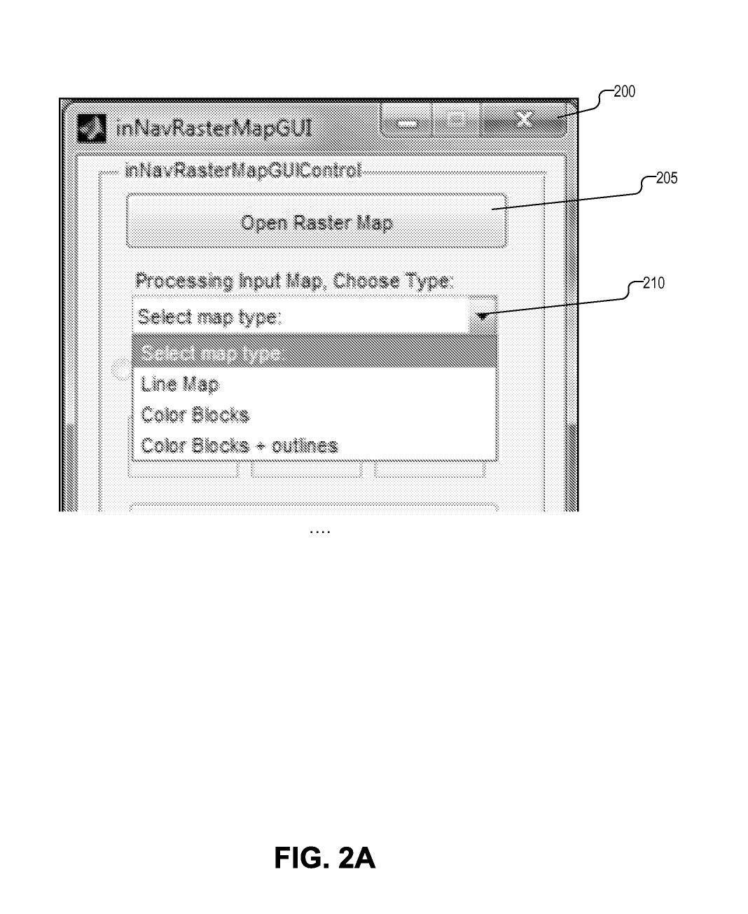

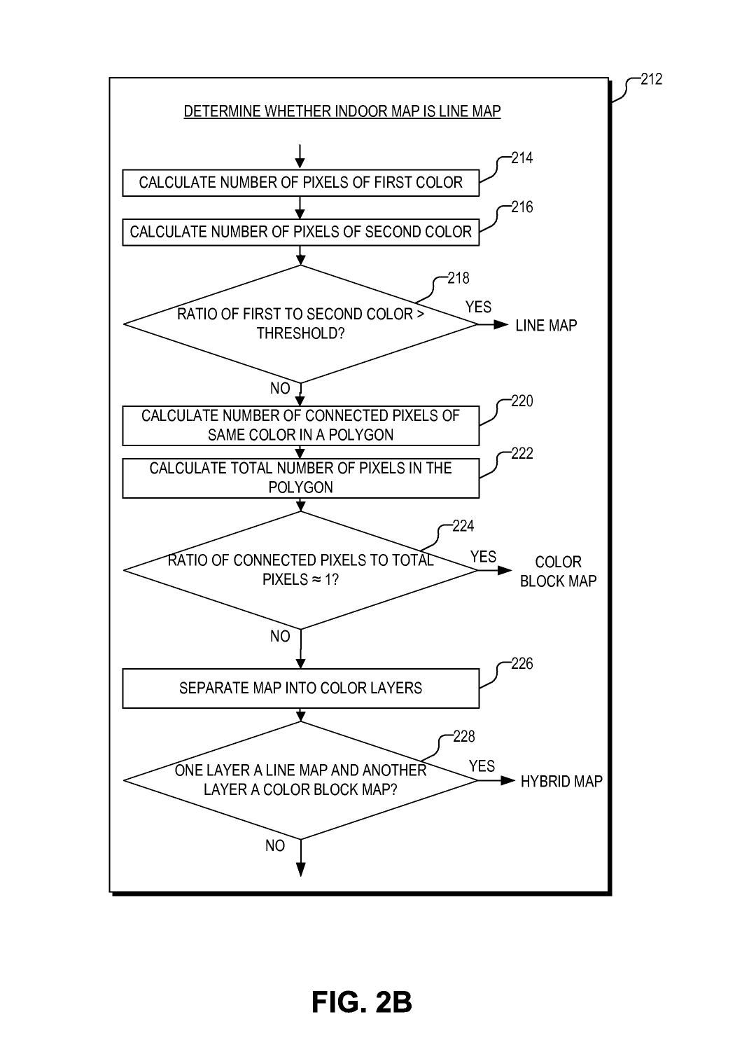

FIG. 1 illustrates a process 100 of converting a raster image of an indoor map into a vector image. In process block 105, a raster image that shows an indoor map is received. In one embodiment, a raster image includes a file that has a data structure representing a grid of pixels. The raster image file may be in a variety of formats, including, but not limited to, *.bmp, *.jpeg, *.tiff, *.raw, *.gif, *.png, etc. The raster image may be received by way of a user interface, such as user interface 200 of FIG. 2A. User interface 200 includes a button 205 that allows a user (not shown) to input a filename and location of the raster image that is to be converted.

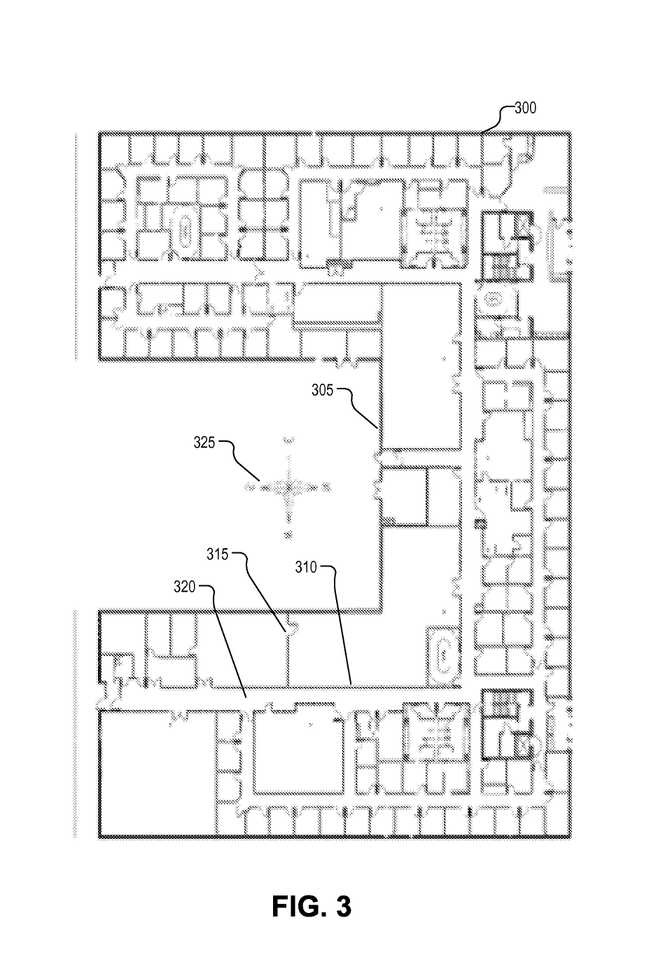

Once the raster image is received, the map type may be categorized. A map included in the raster image may be of a variety of types. One type may be a line map, such as line map 300 of FIG. 3. Line map 300 is generally a two-tone image that includes lines representing various features of a building structure. For example, line map 300 includes line 305 to show a building boundary, line 310 to show an interior wall, and line 315 to show a doorway. Line map 300 may also illustrate a hallway 320 and may additionally include non-building structures (i.e., annotations), such as annotation 325.

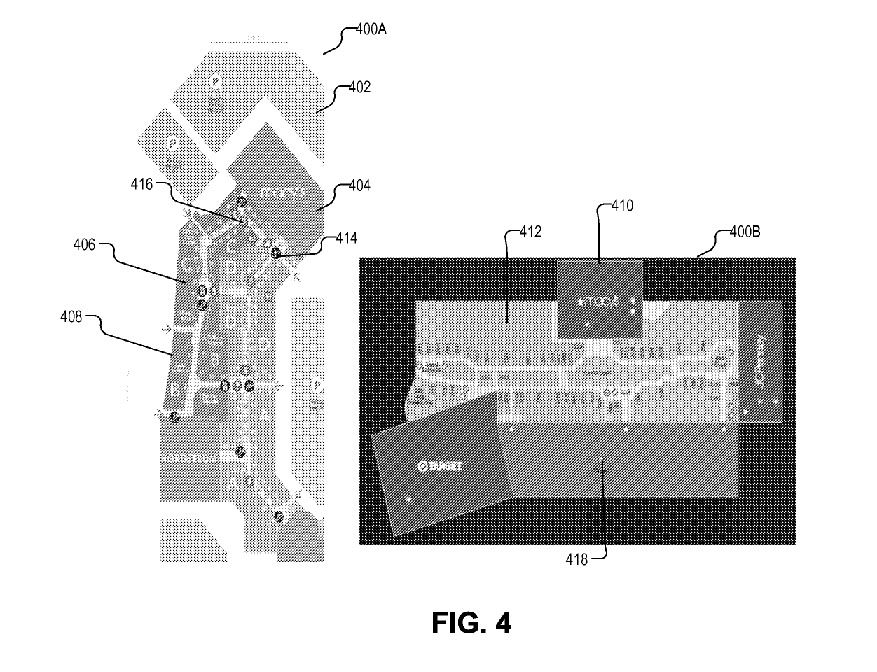

A second type of map may be a color-block map, such as color-block maps 400A and 400B of FIG. 4. As shown, color-block maps 400A and 400B show regions of the building structure as colored blocks. For example, maps 400A and 400B include colored blocks 402, 404, 406, 408, 410, and 412. By way of further example, the colored blocks denote different regions of the map with differing colors. Color-block maps 400A and 400B also include annotations 414, 416, and 418.

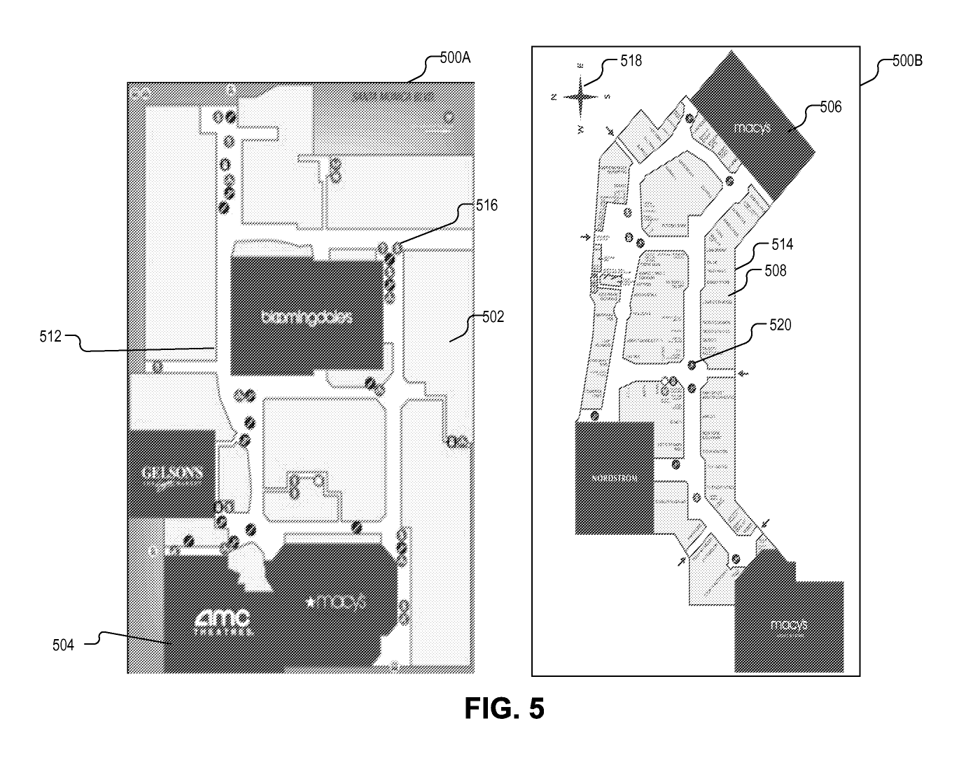

A third type of map may be a hybrid map, such as hybrid maps 500A and 500B of FIG. 5. As shown in FIG. 5, hybrid maps 500A and 500B show regions of the building structure as outlined color blocks. For example, maps 500A and 500B include colored blocks 502, 504, 506, and 508, and outlines 512 and 514. Further included in hybrid maps 500A and 500B are annotations 516, 518, and 520.

Referring now back to FIG. 2A, user interface 200 may provide for user input defining the map type, by way of example pull-down menu 210. As shown, pull-down menu 210 allows the user to select one of three map types: line map, color-block, and color-block+outlines (i.e., hybrid). As shown in FIG. 1, after the map type is input, decision block 110 determines whether a line map type was selected. If not, process 100 proceeds to process block 115 where the non-line map is converted into a line map. For example, if a color-block map type was selected then the color-block map is converted into a line map. Similarly, if a hybrid map type was selected then the hybrid map type is converted into a line map.

In one embodiment, the categorization of the map type may be done automatically rather than in response to user input. That is, software and/or hardware may be implemented that automatically detects whether the received raster image is a line map, color-block map, or a hybrid map. By way of example, FIG. 2B illustrates a process 212 of automatically determining the map type. Process 212 is one possible implementation of decision block 110 of FIG. 1.

Process 212 may begin by testing whether the received indoor map is a line map. As can be seen from the example line map 300 of FIG. 3, the ratio of background pixels (i.e., white) to foreground pixels (i.e., black) is high (i.e., there are many more white pixels than black pixels). This high ratio of pixels of one color to pixels of another color is often indicative of a line map type. Thus, process 212 begins at process block 214 by calculating the number of pixels of a first color. Process block 216 then calculates the number of pixels of a second color. In decision block 218, the ratio of the pixels of the first color to pixels of the second color is compared with a threshold number (e.g., one which corresponds with a line map characteristic feature). If the ratio is greater than the threshold then the received map is determined to be a line map. If not, process 212 may proceed to test whether the received map is of the other types.

Referring briefly to the color-block maps of FIG. 4, it can be seen that for any defined polygon in the color-block map, the number of connected pixels of one color in the polygon is roughly equal to the polygon's total number of pixels. For example, the polygon defined by color block 410 may include x number of connected red pixels and approximately x number of total pixels included in the polygon. Having an equal number of connected pixels and total pixels of one or more polygons is often indicative of a color-block map type. Thus, beginning at process block 220, process 212 includes calculating the number of connected pixels of the same color included in one or more polygons of the received raster image. Next, in process block 222, the total number of pixels in the polygon(s) is calculated. In decision block 224, if the ratio of the connected pixels to the total pixels is approximately equal to one (1) then the received map is determined to be a color-block map.

If the received raster image is determined to not be a line map and not a color-block map, then process 212 may include testing whether the raster image is a hybrid-type map. As mentioned above, hybrid maps 500A and 500B of FIG. 5, include outlined colored blocks. Thus, hybrid maps exhibit characteristics of both a line map (i.e., the outlines) and a color-block map (i.e., the colored blocks). Therefore, process 212 includes process block 226 which separates the received raster image into color layers (i.e., one layer for each color). Next, in decision block 228 it is determined whether at least one of the layers is a line map and whether at least another of the layers is a color-block map. If so, then the received map is determined to be a hybrid map. The processes used to determine whether a layer is a line map or color-block map may be the same as those described above in process blocks 214-224. Also, although FIG. 2B illustrates process 212 as first determining whether the received raster image is a line map and then subsequently testing whether it is a color block map and hybrid map, the testing of maps types may be done in any order consistent with the teachings of the present disclosure.

Referring now back to FIG. 1, next in process block 120, the raster image, now including a line map, is processed. In accordance with embodiments that will be disclosed in more detail below, various image processing is applied to the raster image to prepare the image for the vector conversion of process block 125. In process block 125, vector lines are extracted from the processed raster image.

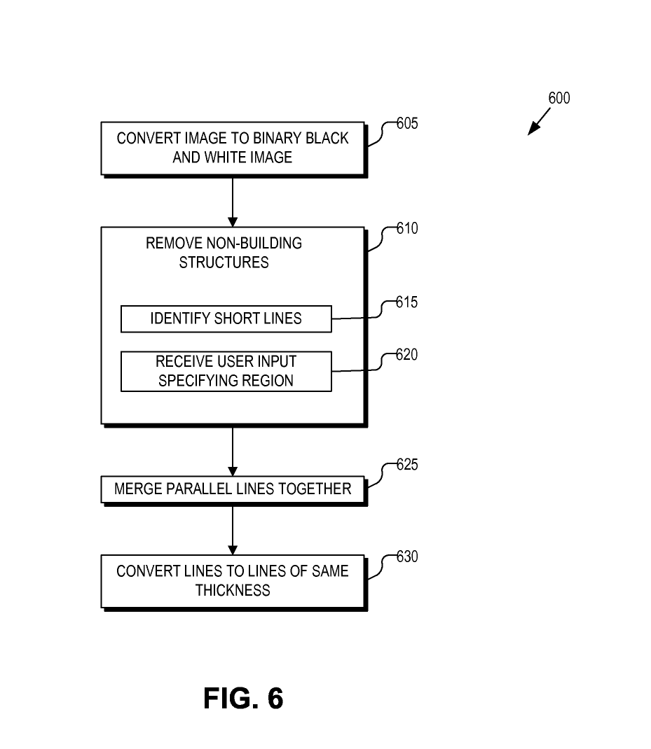

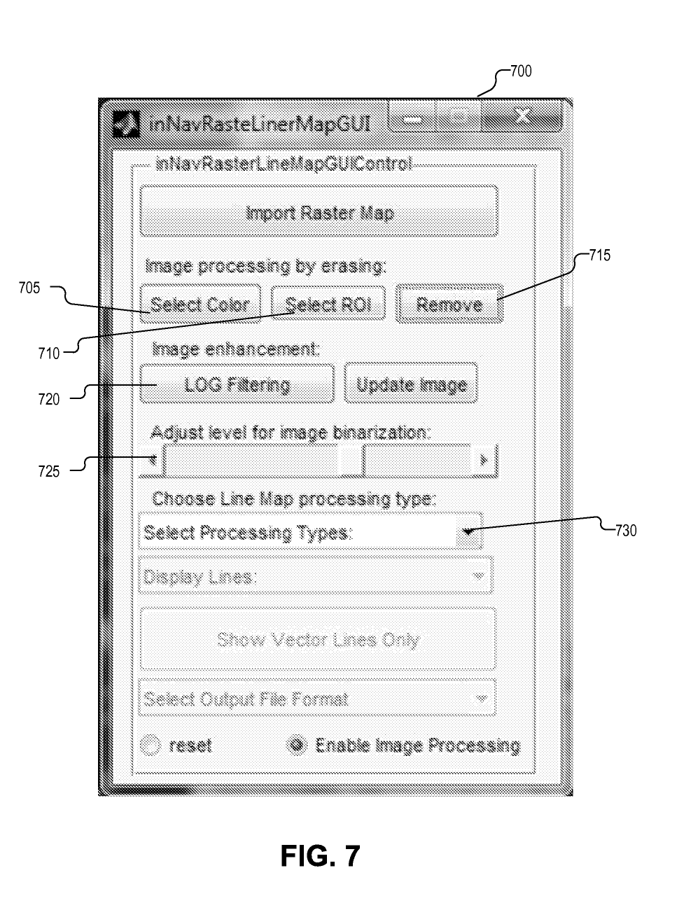

FIG. 6 illustrates the processing 600 of a raster image map. Process 600 is one possible implementation of process block 120 of FIG. 1. In process block 605 the raster image is converted into a binary black and white image. In one example, the level of binarization is user-selectable. For example, user interface 700 of FIG. 7 may provide a slider-bar 725 to allow the user to adjust the level of image binarization.

Next, in process block 610, non-building structures (i.e., annotations) are removed. Embodiments of the present invention may employ a variety of methods to identify annotations in a line map. In one example, user input is received (i.e., process block 620) that identifies a region on the displayed line map to be removed. User interface 700 may provide this option by way of button 710, which allows the user to draw a closed region on the map, where any features inside the region are to be removed from the image. In another example, the identification of annotations may be done automatically. For example, the line map includes lines that represent walls of the building structure. Longs lines typically have a higher probability of being a wall, while shorter lines may be indicative of a non-building structure. Thus, in one embodiment, process 600 includes the identification of short lines 615. The identification of short lines may include identifying lines in the raster image that have a length that is less than a threshold amount. Once the non-building structure is identified, whether it be by user input or automatically, the non-building structure is then removed from the image. By way of example, user interface 700 may provide a button 715 to allow the user to remove the identified non-building structures. In one embodiment, removal of the non-building structure may include refilling the removed structure with a background color (e.g., white).

Referring again to process 600 of FIG. 6, some line maps may include parallel lines that represent two sides of the same wall. Thus, process block 625 provides for the option for the merging together of parallel lines that are in close proximity to one another. As shown in FIG. 7, user interface 700 includes a pull-down menu 730 to allow the user to select the line map processing type. In one example, the menu 730 may provide for three options: no line merging, strict line merging, and relaxed line merging. Strict line merging may provide for the merging of lines together only when they are in extremely close proximity to one another (e.g., 3 pixels or less), while relaxed line merging may allow for the merging together of lines that are further apart (e.g., 5 pixels or less).

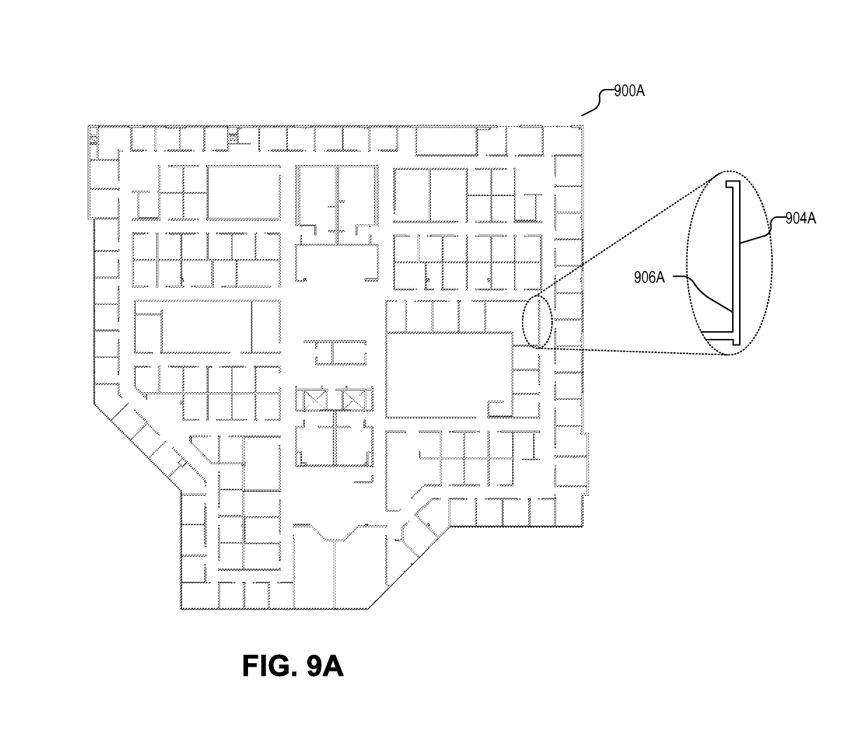

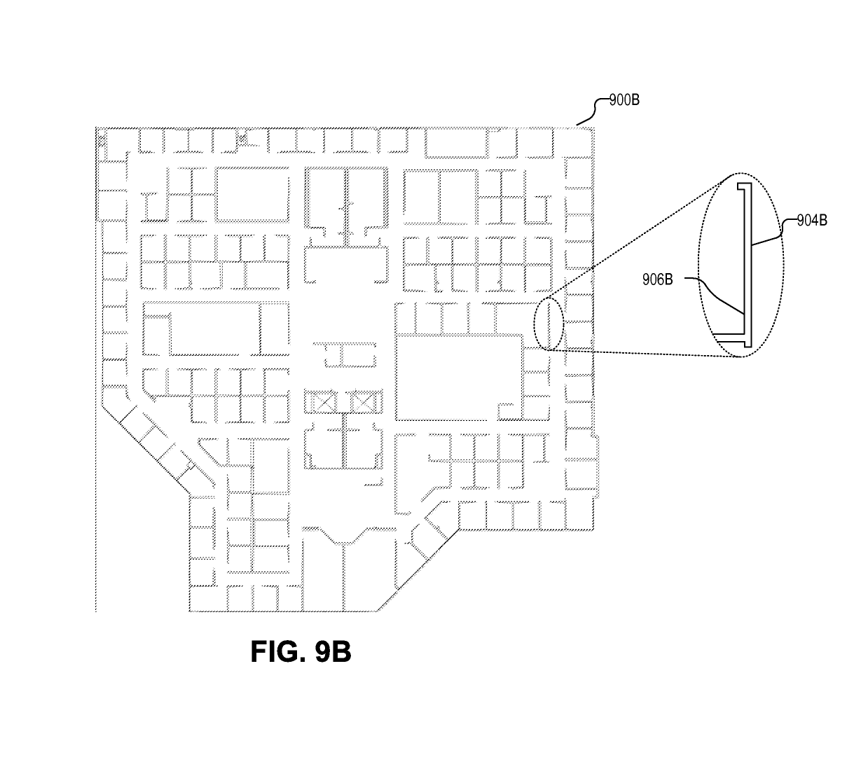

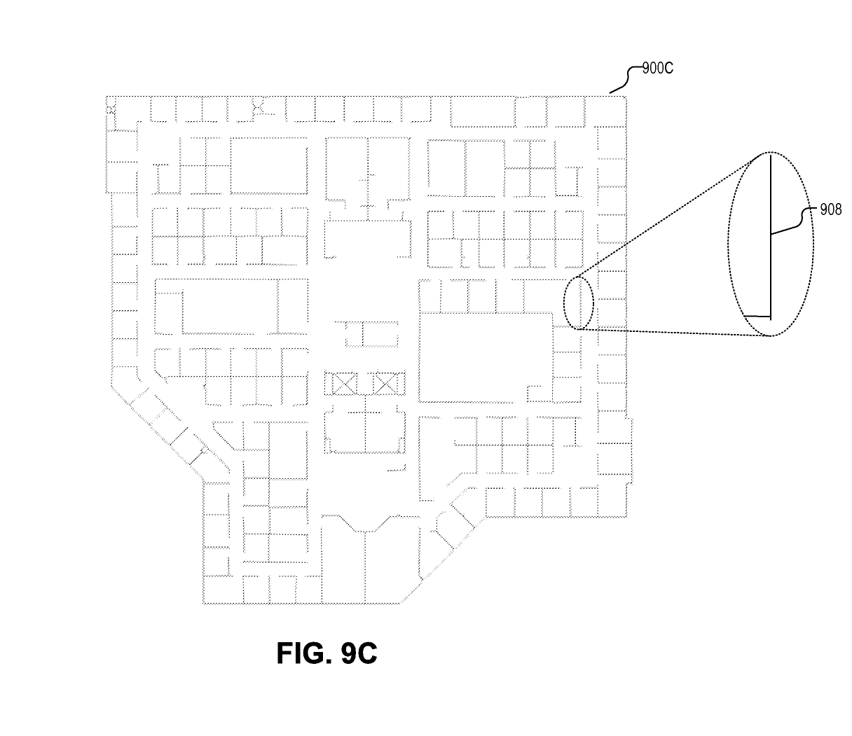

FIGS. 9A-9C illustrate the effects of line merging on a line map before and after vector conversion. FIG. 9A illustrates a raster image of a line map 900A having several parallel lines 904A and 906A in close proximity to one another. FIG. 9B illustrates the conversion of the raster image of FIG. 9A into a vector image without line merging. As can be seen from vector map 900B parallel lines 904A and 906A have been converted into parallel vector lines 904B and 906B. However, FIG. 9C illustrates the conversion of the raster image of FIG. 9A into a vector image with line merging. As shown in FIG. 9C parallel lines 904A and 906A have been merged into a single vector line 908.

Referring now back to FIG. 6, process 600 further includes process block 630 to convert the lines of the raster image to lines of the same thickness. In one embodiment, thick lines are thinned, such that all lines have the same thickness (e.g., 1 pixel).

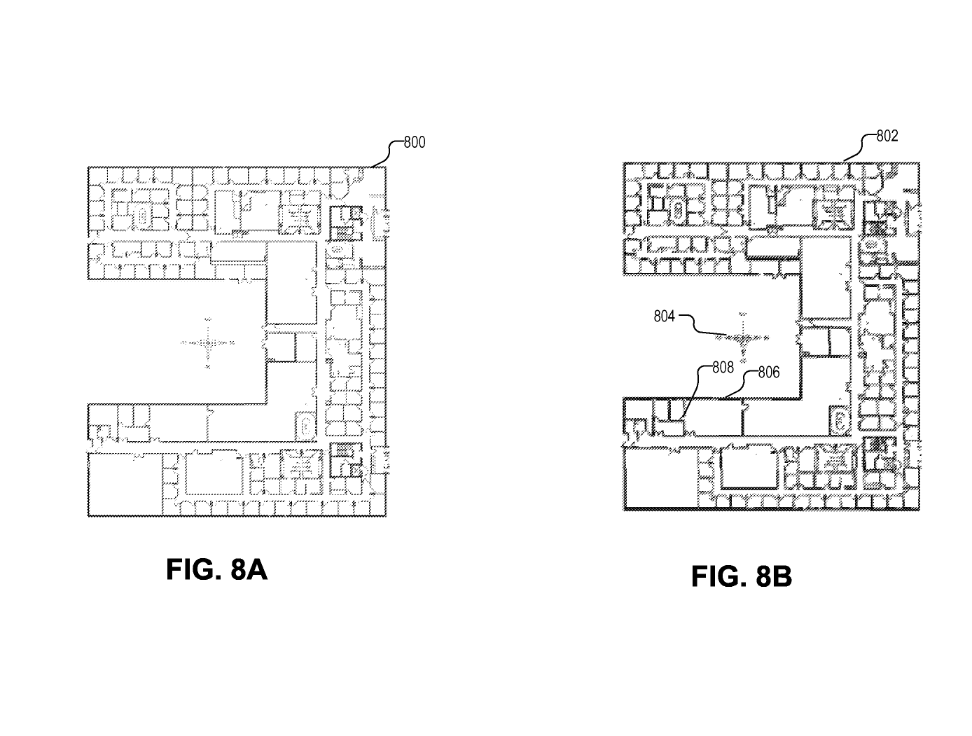

FIGS. 8A and 8B illustrate the conversion of a line map from a raster image 800 to a vector image 802. As shown in FIG. 8B, annotation 804 was not removed and remains in the vector image 802. As mentioned above, longer lines may represent a higher probability of being a wall, while shorter lines may be indicative of annotations. Thus, in one embodiment, vector lines of vector image 802 may be color-coded according to their length. For example, in the embodiment of FIG. 8B, vector line 806 may colored blue because it is a relatively long line and is likely indicative of a wall, whereas vector line 808 is a relatively short line and may represent a non-building structure, such as a doorway, and is therefore colored red. Thus, in some embodiments, shorter lines are colored a different (e.g., red) from longer lines (e.g., blue). By way of example, the coloring of lines may be based on heuristics. However, if a user determines that a short line is a valid building structure, they may add the short line to a list of building structures and it may then be colored the same as the long lines.

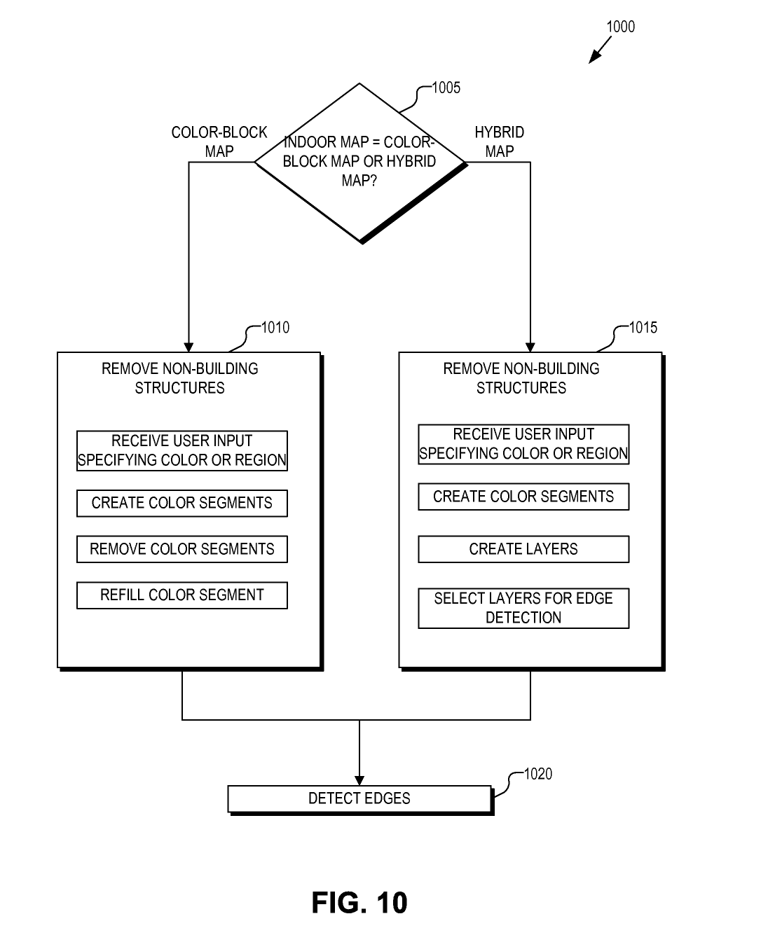

FIG. 10 illustrates a process 1000 of converting a color-block map and a hybrid map into a line map. Process 1000 is one possible implementation of process block 115 of FIG. 1. In response to user-input, such as user-input from pull-down menu 210 of user interface 200 of FIG. 2, indicating the map type, decision block 1005 determines whether the selected map type was a color-block map or a hybrid map. If a color-block map, then process 1000 proceeds to process block 1010. If a hybrid map, then process proceeds to process block 1015.

In process block 1010, non-building structures are first removed from the color-block map. Embodiments of the present invention may employ a variety of methods to identify annotations in a color-block map. In one example, user input is received that identifies a region on the displayed line map to be removed. User interface 700 may provide this option by way of button 710, which allows the user to draw a closed region on the map, where any features inside the region are to be removed from the image. In another example, the identification of annotations in a color-block map may be done by way of receiving user-input specifying a color of the annotation to be removed. User interface 700 may provide this option by way of button 705, which allows the user to select a color on the map of the non-building structure.

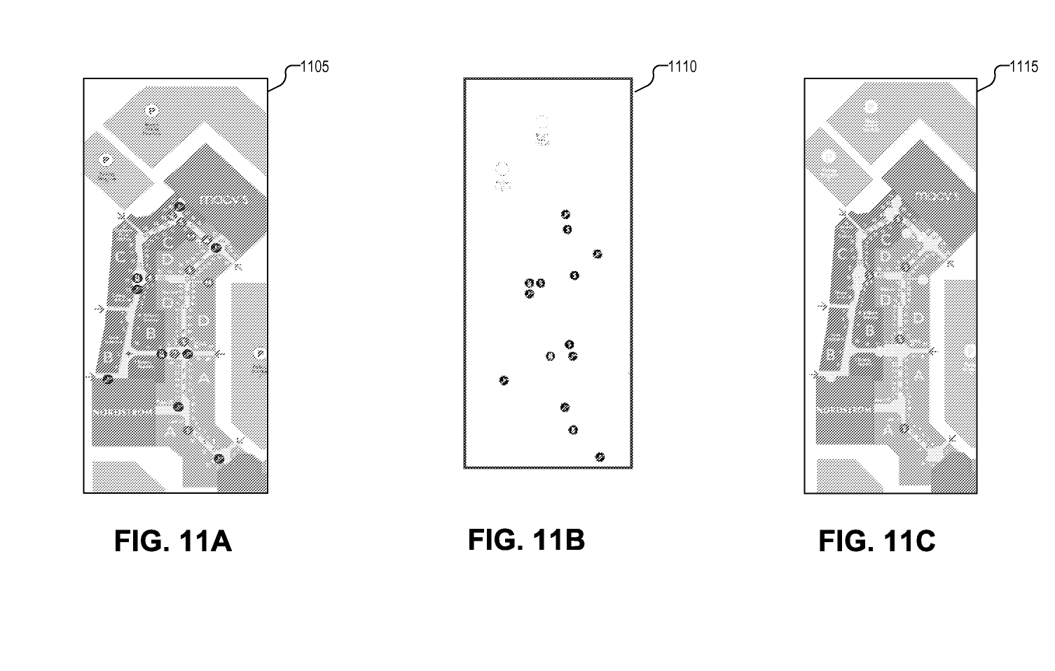

In yet another method of identifying non-building structures in a color-block map, process 1000 may create color segments in the raster image based on colors included in the colored blocks. In the illustrated example of FIG. 11A, one segment is created for an annotation of one color, while another segment is created for the colored block surrounding the annotation. It is then determined whether each color segment is a non-building structure. In one example, smaller color segments have a higher probability of being an annotation, while larger color segments are more likely to represent the building structure. Thus, process 1000 may identify color segments which are smaller than a threshold amount as non-building structures. The detected annotations of color-block map 1105 of FIG. 11A are shown in FIG. 11B as annotations 1110. Next, as shown in FIG. 11C, color segments which are identified as non-building structures are then removed from the image and refilled with a background color (e.g., white). As shown in FIG. 11D, small enclosed areas are then re-colored with their respective surrounding color. FIG. 11E illustrates the resultant vector image 1125 after edge detection to convert to a line map and the subsequent extraction of the vector lines. In one embodiment, process 1000 of FIG. 10 performs edge detection 1020 by way of a Laplacian of Gaussian filter.

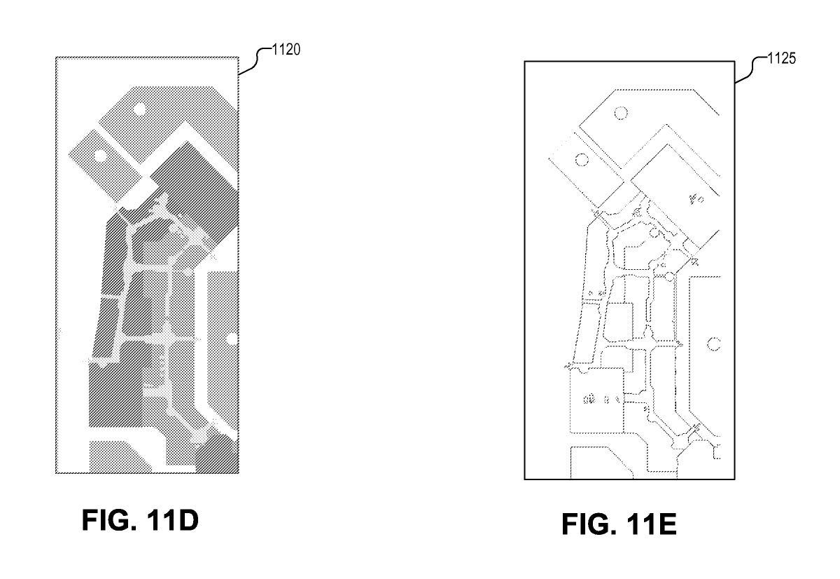

As with the color-block map, embodiments of the present invention may employ a variety of similar methods to identify annotations in a hybrid map. For example, user-input may be received specifying a color or region of the non-building structure to be removed. In addition, color segments may be created, where small segments are removed from the raster image and refilled with the background color. FIG. 12A illustrates a hybrid map 1205 that is to be converted into a vector map. The segmented map 1205 may be first separated into different layers based color, one layer for each color. The layers are then selected for edge detection based, at least in part, on whether the layer has substantially large connected components to represent the building structure. For example, FIG. 12B illustrates the map after an annotation layer is identified, removed and refilled with the background color (e.g., white). FIG. 12C illustrates the resultant vector image 1215 after edge detection and extraction of the vector lines.

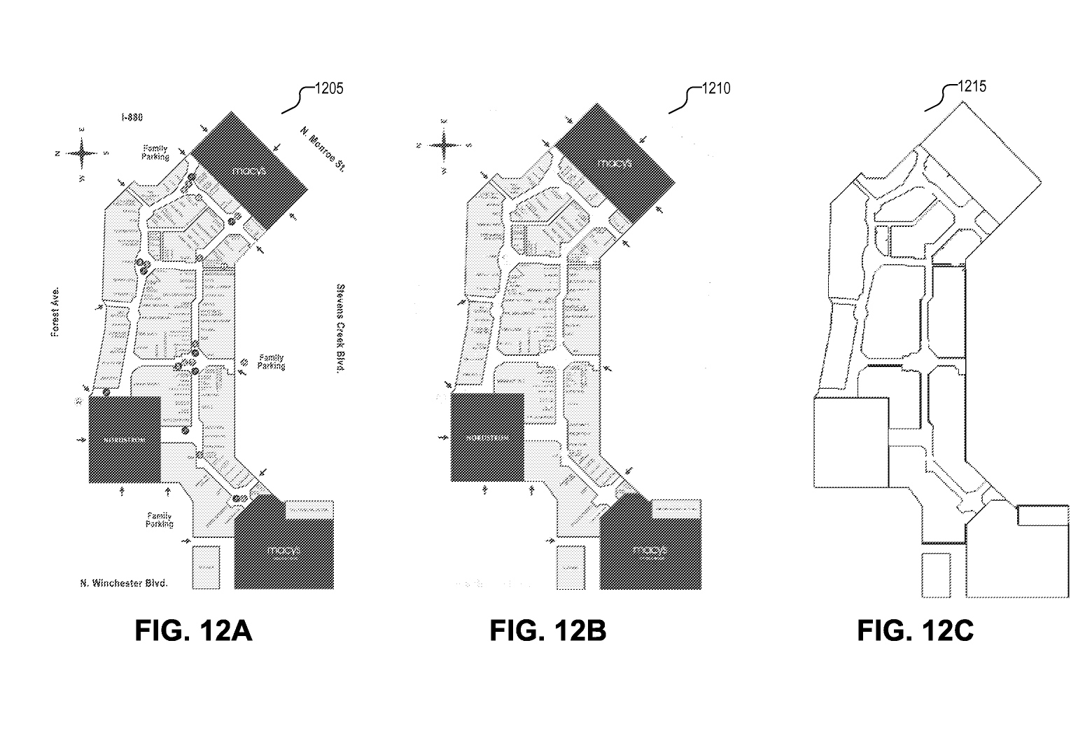

FIG. 13 illustrates a process of layering the hybrid map of FIG. 12A. As shown, creating layers of hybrid map 1305 results in several layers 1310-1335 being created. As mentioned above, each layer may be representative of one color of hybrid map 1305. Layers with large connected structures may be identified as layers for edge detection, while other layers may be identified as annotation layers, or even as layers for discarding. For example, layers 1310 and 1315 may be identified as edge layers, while layer 1320 is identified as an annotation layer. Even still, layers 1330, 1325 and 1335 may be identified as “other layers” and discarded (i.e., not used for edge detection).

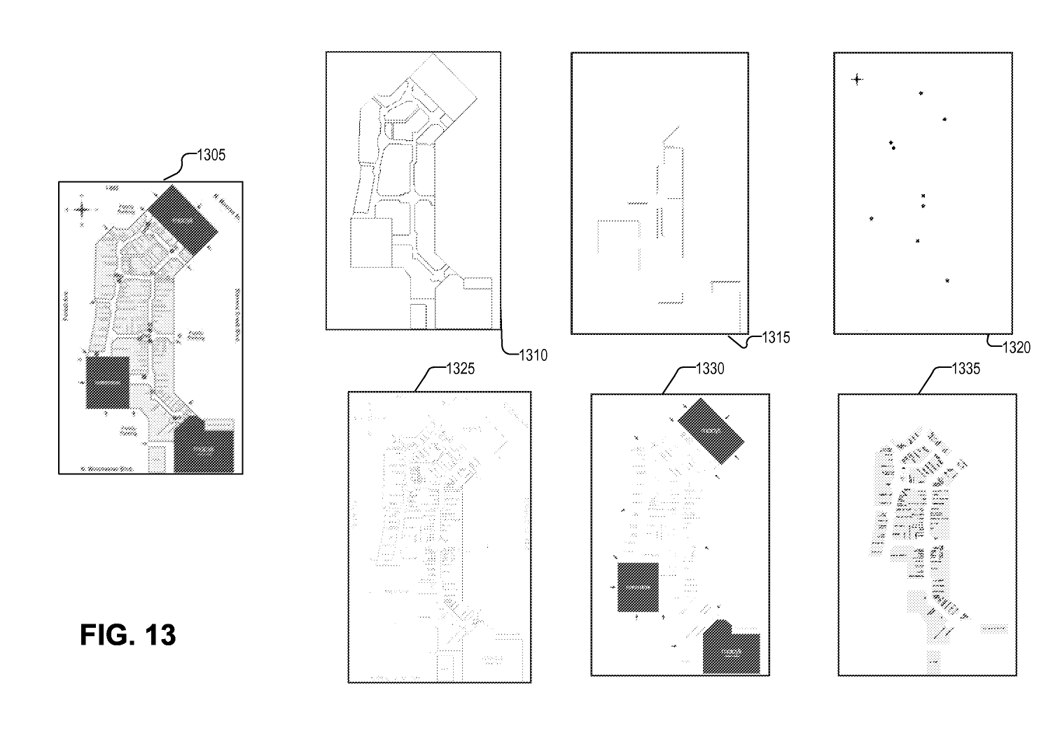

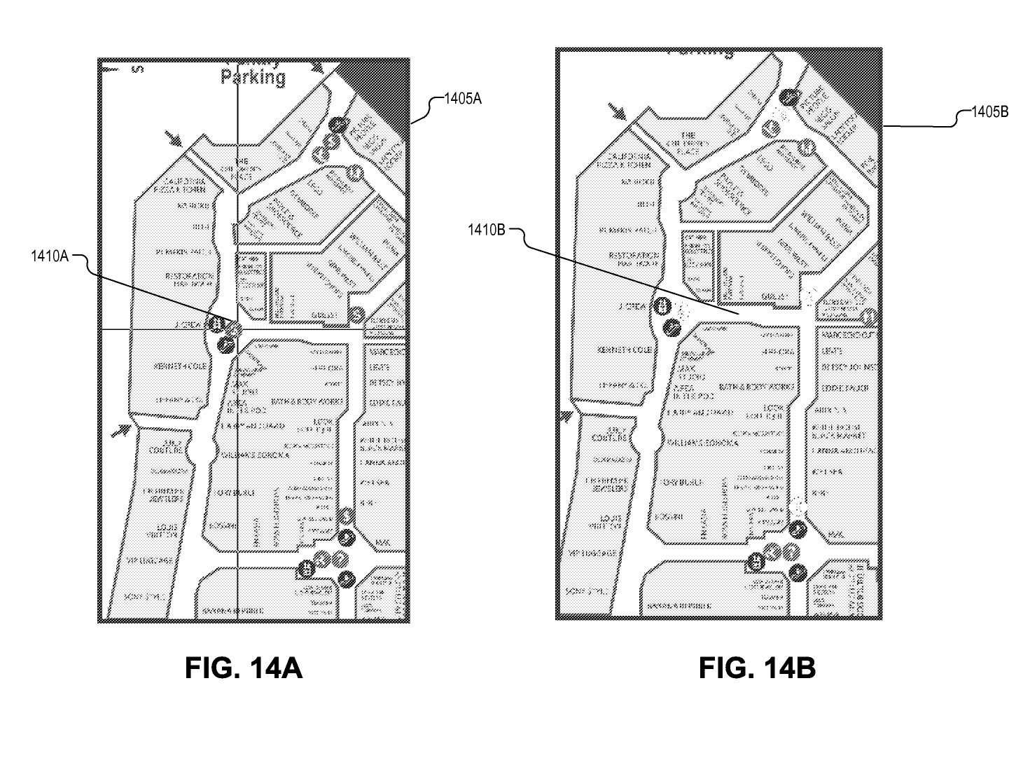

FIGS. 14A-14B illustrate a process of annotation removal by way of user-selection of a color 1410A, while FIGS. 15A-15B illustrate a process of annotation removal by way of user-selection of a region 1510A.

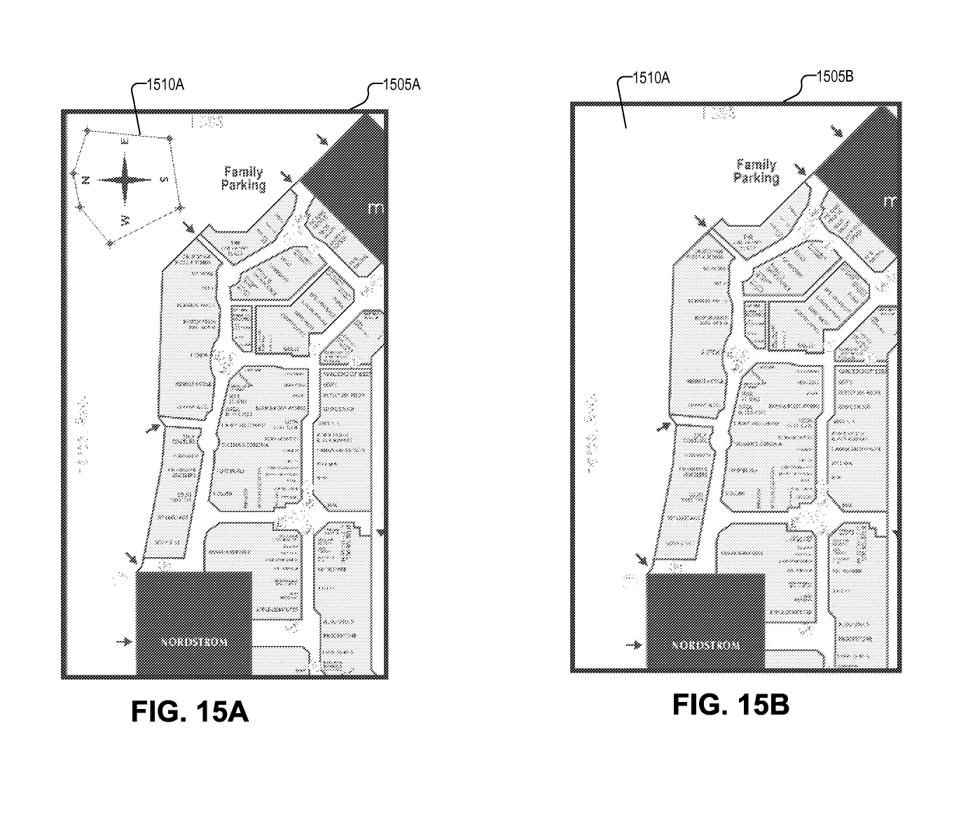

FIG. 16 is a functional block diagram of a navigation system 1600. As shown, navigation system 1600 may include a map server 1605, a network 1610, a map source 1615, and a mobile device 1620. Map source 1615 may comprise a memory and may store electronic maps that may be in raster format or in vector format. Electronic maps may include drawings of line segments which may indicate various interior features of a building structure.

In one implementation, map source 1615 may create electronic maps by scanning paper blueprints for a building into an electronic format that is not correctly scaled. Alternatively, map source 1615 may acquire electronic maps from an architectural firm that designed a building or from public records, for example.

Electronic maps 1625 may be transmitted by map source 1615 to map server 1605 via network 1610. Map source 1615 may comprise a database or server, for example. In one implementation, map server 1605 may transmit a request for a particular basic electronic map to map source 1615 and in response the particular electronic map may be transmitted to map server 1605. One or more maps in map source 1615 may be scanned from blueprint or other documents.

Map server 1605 may provide a user interface for a user to convert a raster image map into a vector image map.

The electronic vector image map may subsequently be utilized by a navigation system to generate various position assistance data that may be used to provide routing directions or instructions to guide a person from a starting location depicted on a map to a destination location in an office, shopping mall, stadium, or other indoor environment. A person may be guided through one or more hallways to reach a destination location. Electronic maps and/or routing directions 1630 may be transmitted to a user's mobile station 1620. For example, such electronic maps and/or routing directions may be presented on a display screen of mobile station 1620. Routing directions may also be audibly presented to a user via a speaker of mobile station 1620 or in communication with mobile device 1620. Map server 1605, map source 1615 and mobile device 1620 may be separate devices or combined in various combinations (e.g., all combined into mobile device 1620; map source 1615 combined into map server 1605, etc.).

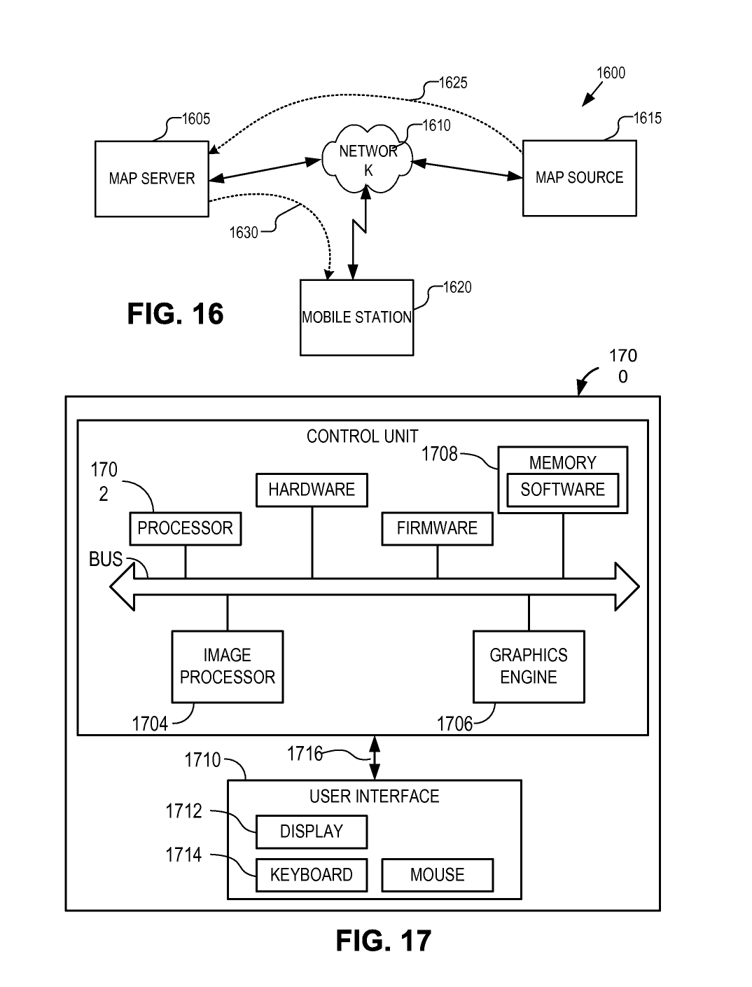

FIG. 17 is a block diagram illustrating a system in which embodiments of the invention may be practiced. The system may be a computing device 1700, which may include a general purpose processor 1702, image processor 1704, graphics engine 1706 and a memory 1708. Device 1700 may be a: mobile device, wireless device, cell phone, personal digital assistant, mobile computer, tablet, personal computer, laptop computer, or any type of device that has processing capabilities. Device 1700 may also be one possible implementation of map server 1605 of FIG. 16.

The device 1700 may include a user interface 1710 that includes a means for displaying the images, such as the display 1712. The user interface 1710 may also include a keyboard 1714 or other input device through which user input 1716 can be input into the device 1700. If desired, the keyboard 1714 may be obviated by integrating a virtual keypad into the display 1712 with a touch sensor.

Memory 1708 may be adapted to store computer-readable instructions, which are executable to perform one or more of processes, implementations, or examples thereof which are described herein. Processor 1702 may be adapted to access and execute such machine-readable instructions. Through execution of these computer-readable instructions, processor 1702 may direct various elements of device 1700 to perform one or more functions.

Memory 1708 may also store electronic maps to be analyzed and converted from a raster image to a vector image, as discussed above. A network adapter included in the hardware of device 1700 may transmit one or more electronic maps to another device, such as a user's mobile device. Upon receipt of such electronic maps, a user's mobile device may present updated electronic maps via a display device. The network adapter may also receive one or more electronic maps for analysis from an electronic map source.

The order in which some or all of the process blocks appear in each process should not be deemed limiting. Rather, one of ordinary skill in the art having the benefit of the present disclosure will understand that some of the process blocks may be executed in a variety of orders not illustrated.

The teachings herein may be incorporated into (e.g., implemented within or performed by) a variety of apparatuses (e.g., devices). For example, one or more aspects taught herein may be incorporated into a mobile station, phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device. These devices may have different power and data requirements and may result in different power profiles generated for each feature or set of features.

As used herein, a mobile station (MS) refers to a device such as a cellular or other wireless communication device, personal communication system (PCS) device, personal navigation device (PND), Personal Information Manager (PIM), Personal Digital Assistant (PDA), laptop, tablet or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments referred to various colors, color-blocks, colored lines, etc. It is noted that the drawings accompanying this disclosure include various hatching and cross-hatching to denote the various colors, color-blocks, and colored lines.

Various modifications to the embodiments disclosed herein will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method for converting a raster image map to a vector image map, the method comprising:
receiving an electronic raster image that shows an indoor map of a building structure;
determining whether the indoor map is a line map and if not, converting the indoor map into a line map, wherein the line map includes lines that represent features of the building structure;
processing the electronic raster image to generate a processed raster image of the indoor map; and
extracting vector lines from the processed raster image to generate an electronic vector image that shows the indoor map of the building structure.

2. The method of claim 1, wherein determining whether the indoor map is a line map includes determining whether a ratio of pixels of a first color to pixels of a second color is above a threshold.

3. The method of claim 1, wherein the processing of the electronic raster image includes at least one of:
removing non-building structures from the indoor map;
merging lines together that are in parallel and in close proximity to one another; and
converting the lines of the line map to lines of a same thickness.

4. The method of claim 3, wherein the non-building structure includes a first line having a length, the method further comprising automatically identifying the first line as a non-building structure if the length of the first line is less than a threshold amount and automatically removing the identified non-building structure from the indoor map.

5. The method of claim 3, wherein removing non-building structures from the indoor map includes receiving user input specifying a region of the indoor map that is a non-building structure.

6. The method of claim 1, further comprising determining whether the indoor map is a color-block map, where the color-block map shows regions of the building structure as colored blocks, wherein determining whether the indoor map is a color-block map includes determining whether a ratio of connected pixels of a first color included in a polygon to a total number of pixels of the polygon is approximately equal to one.

7. The method of claim 1, wherein converting the indoor map into a line map includes converting a color-block map into a line map, the method comprising:
removing non-building structures from the indoor map; and
detecting edges of the color-block map to generate the line map.

8. The method of claim 7, wherein removing non-building structures from the indoor map comprises:
creating one or more color segments in the raster image based on colors included in colored blocks of the color-block map;
determining whether each of the one or more color segments is a non-building structure;
removing any color segment identified as a non-building structure; and
refilling the removed color segment with a background color.

9. The method of claim 8, wherein determining whether each of the one or more color segments is a non-building structure includes receiving user input specifying the color of the color segment that is a non-building structure.

10. The method of claim 8, wherein determining whether a color segment is a non-building structure includes receiving user input specifying a region that includes the color segment.

11. The method of claim 8, wherein determining whether a color segment is a non-building structure includes determining whether a size of the color segment is less than a threshold amount.

12. The method of claim 7, wherein detecting edges of the color-block map includes applying a Laplacian of Gaussian filter to the color-block map to extract lines for the line map.

13. The method of claim 1, further comprising determining whether the indoor map is a hybrid map, wherein determining whether the indoor map is a hybrid map includes separating the indoor map into color layers and determining whether a first color layer is a line map and a second layer is a color-block map.

14. The method of claim 13, wherein converting the indoor map into a line map includes converting a hybrid map into a line map, the method comprising:
creating a layer for each color in the hybrid map;
selecting at least one layer that has substantially large connected components to represent the building structures; and
detecting edges of each selected layer to generate the line map.

15. The method of claim 14, wherein detecting edges of each selected layer includes applying a Laplacian of Gaussian filter to the selected layer to extract lines for the line map.

16. A computer-readable medium including program code stored thereon for converting a raster image map to a vector image map, the program code comprising instructions to:
receive an electronic raster image that shows an indoor map of a building structure;
determine whether the indoor map is a line map and if not, converting the indoor map into a line map, wherein the line map includes lines that represent features of the building structure;
process the electronic raster image to generate a processed raster image of the indoor map; and
extract vector lines from the processed raster image to generate an electronic vector image that shows the indoor map of the building structure.

17. The computer-readable medium of claim 16, wherein the instructions to determine whether the indoor map is a line map includes instructions to determine whether a ratio of pixels of a first color to pixels of a second color is above a threshold.

18. The computer-readable medium of claim 16, wherein the instructions to process the electronic raster image includes at least one of the instructions to:
remove non-building structures from the indoor map;
merge lines together that are in parallel and in close proximity to one another; and
convert the lines of the line map to lines of a same thickness.

19. The computer-readable medium of claim 16, further comprising instructions to determine whether the indoor map is a color-block map, where the color-block map shows regions of the building structure as colored blocks, wherein the instructions to determine whether the indoor map is a color-block map includes instructions to determine whether a ratio of connected pixels of a first color included in a polygon to a total number of pixels of the polygon is approximately equal to one.

20. The computer-readable medium of claim 16, wherein the instructions to convert the indoor map into a line map includes instructions to convert a color-block map into a line map, the program code further comprising instructions to:
remove non-building structures from the indoor map; and
detect edges of the color-block map to generate the line map.

21. The computer-readable medium of claim 20, wherein the instructions to remove non-building structures from the indoor map comprises instructions to:
create one or more color segments in the raster image based on colors included in colored blocks of the color-block map;
determine whether each of the one or more color segments is a non-building structure;
remove any color segment identified as a non-building structure; and
refill the removed color segment with a background color.

22. The computer-readable medium of claim 21, wherein the instructions to determine whether each of the one or more color segments is a non-building structure includes instructions to receive user input specifying the color of the color segment that is a non-building structure.

23. The computer-readable medium of claim 21, wherein the instructions to determine whether a color segment is a non-building structure includes instructions to determine whether a size of the color segment is less than a threshold amount.

24. The computer-readable medium of claim 16, further comprising instructions to determine whether the indoor map is a hybrid map, wherein the instructions to determine whether the indoor map is a hybrid map includes instructions to separate the indoor map into color layers and to determine whether a first color layer is a line map and a second layer is a color-block map.

25. The computer-readable medium of claim 24, wherein the instructions to convert the indoor map into a line map includes instructions to convert a hybrid map into a line map, the program code further comprising instructions to:
create a layer for each color in the hybrid map;
select at least one layer that has substantially large connected components to represent the building structures; and
detect edges of each selected layer to generate the line map.

26. A map server, comprising:
memory adapted to store program code for converting a raster image map to a vector image map; and
a processing unit adapted to access and execute instructions included in the program code, wherein when the instructions are executed by the processing unit, the processing unit directs the map server to:
receive an electronic raster image that shows an indoor map of a building structure;
determine whether the indoor map is a line map and if not, convert the indoor map into a line map, wherein the line map includes lines that represent features of the building structure;
process the electronic raster image to generate a processed raster image of the indoor map; and
extract vector lines from the processed raster image to generate an electronic vector image that shows the indoor map of the building structure.

27. The map server of claim 26, wherein the instructions to determine whether the indoor map is a line map includes instructions to determine whether a ratio of pixels of a first color to pixels of a second color is above a threshold.

28. The map server of claim 26, wherein the instructions to process the electronic raster image includes at least one of the instructions to:
remove non-building structures from the indoor map;
merge lines together that are in parallel and in close proximity to one another; and
convert the lines of the line map to lines of a same thickness.

29. The map server of claim 26, wherein the program code further includes instruction to direct the map server to determine whether the indoor map is a color-block map, where the color-block map shows regions of the building structure as colored blocks, wherein the instructions to determine whether the indoor map is a color-block map includes instructions to determine whether a ratio of connected pixels of a first color included in a polygon to a total number of pixels of the polygon is approximately equal to one.

30. The computer-readable medium of claim 26, wherein the instructions to convert the indoor map into a line map includes instructions to convert a color-block map into a line map, the program code further comprising instructions to:
remove non-building structures from the indoor map; and
detect edges of the color-block map to generate the line map.

31. The map server claim 30, wherein the instructions to remove non-building structures from the indoor map comprises instructions to:
create one or more color segments in the raster image based on colors included in colored blocks of the color-block map;
determine whether each of the one or more color segments is a non-building structure;
remove any color segment identified as a non-building structure; and
refill the removed color segment with a background color.

32. The map server of claim 26, wherein the program code further comprises instructions to direct the map server to determine whether the indoor map is a hybrid map, wherein the instructions to determine whether the indoor map is a hybrid map includes instructions to separate the indoor map into color layers and to determine whether a first color layer is a line map and a second layer is a color-block map.

33. The map server of claim 32, wherein the instructions to convert the indoor map into a line map includes instructions to convert a hybrid map into a line map, the program code further comprising instructions to direct the map server to:
create a layer for each color in the hybrid map;
select at least one layer that has substantially large connected components to represent the building structures; and
detect edges of each selected layer to generate the line map.

34. A system for converting a raster image map to a vector image map, the system comprising:
means for receiving an electronic raster image that shows an indoor map of a building structure;
means for determining whether the indoor map is a line map and if not, converting the indoor map into a line map, wherein the line map includes lines that represent features of the building structure;
means for processing the electronic raster image to generate a processed raster image of the indoor map; and
means for extracting vector lines from the processed raster image to generate an electronic vector image that shows the indoor map of the building structure.

35. The system of claim 34, wherein the means for determining whether the indoor map is a line map includes means for determining whether a ratio of pixels of a first color to pixels of a second color is above a threshold.

36. The system of claim 34, wherein the means for processing the electronic raster image includes at least one of:
means for removing non-building structures from the indoor map;
means for merging lines together that are in parallel and in close proximity to one another; and
means for converting the lines of the line map to lines of a same thickness.

37. The system of claim 34, further comprising means for determining whether the indoor map is a color-block map, where the color-block map shows regions of the building structure as colored blocks, wherein the means for determining whether the indoor map is a color-block map includes means for determining whether a ratio of connected pixels of a first color included in a polygon to a total number of pixels of the polygon is approximately equal to one.

38. The system of claim 34, wherein the means for converting the indoor map into a line map includes means for converting a color-block map into a line map, the system further comprising:
means for removing non-building structures from the indoor map; and
means for detecting edges of the color-block map to generate the line map.

39. The system of claim 38, wherein the means for removing non-building structures from the indoor map comprises:
means for creating one or more color segments in the raster image based on colors included in colored blocks of the color-block map;
means for determining whether each of the one or more color segment is a non-building structure;
means for removing any color segment identified as a non-building structure; and
means for refilling the removed color segment with a background color.

40. The system of claim 34, further comprising means for determining whether the indoor map is a hybrid map wherein the means for determining whether the indoor map is a hybrid map includes means for separating the indoor map into color layers and determining whether a first color layer is a line map and a second layer is a color-block map.

41. The system of claim 40, wherein the means for converting the indoor map into a line map includes means for converting a hybrid map into a line map, the system further comprising:
means for creating a layer for each color in the hybrid map;
means for selecting at least one layer that has substantially large connected components to represent the building structures; and
means for detecting edges of each selected layer to generate the line map.
